(19) United States
(12) Patent Application Publication
(10) Pub. No.: US 2013/0262306 A1
(43) Pub. Date: Oct. 3, 2013

(54) Method, System and Program Product for Financial Transactions

(71) Applicant: Shezadh Ladha, Mumbai (IN)

(72) Inventor: Shezadh Ladha, Mumbai (IN)

(21) Appl. No.: 13/434,797

(22) Filed: Mar. 29, 2012

(51) Int. Cl. G06Q 20/40

(52) U.S. Cl. 705/44

(57) ABSTRACT

A method, system and program product comprise initializing at least a financial transaction between a first user and a second user, in which the first user and the second user have created accounts by communicating with a server system. The account of the first user is associated with at least a first user's client device, and the account of the second user is associated with at least a second user's client device. A contact between the first user's client device and the second user's client device is recognized. Geographical locations are obtained. The geographical locations are compared for, in part, determining a validity of the financial transaction. At least an amount for the financial transaction is communicated to the server system for transaction processing.

### CROSS-REFERENCE TO RELATED APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to communication systems. More particularly, one or more embodiments of the invention relate to payment systems.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Generally, financial transactions such as, but not limited to, checks, credit cards, debit cards and money orders have many attendant inefficiencies and inadequacies. It is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram for the architecture of an example payment system, in accordance with an embodiment of the present invention;

FIG. 2 is a block diagram for the example client described with reference to FIG. 1, in accordance with an embodiment of the present invention;

FIG. 3 is a presentation for the example client described with reference to FIGS. 1-2, in accordance with an embodiment of the present invention;

FIG. 4A is a presentation for the example client described with reference to FIGS. 1-2, in accordance with an embodiment of the present invention;

FIG. 4B is a presentation for the example client described with reference to FIGS. 1-2 and FIG. 4A, in accordance with an embodiment of the present invention;

FIG. 5 is a presentation for the example client described with reference to FIGS. 1-2, in accordance with an embodiment of the present invention;

FIG. 6 is a presentation for the example client described with reference to FIGS. 1-2, in accordance with an embodiment of the present invention;

FIG. 7 is a presentation for the example client described with reference to FIGS. 1-2, in accordance with an embodiment of the present invention;

FIG. 8 is a presentation for the example client described with reference to FIGS. 1-2, in accordance with an embodiment of the present invention;

FIG. 9 is a presentation for the example client described with reference to FIGS. 1-2, in accordance with an embodiment of the present invention;

FIG. 10 is a presentation for the example client described with reference to FIGS. 1-2, in accordance with an embodiment of the present invention;

FIGS. 11A-B illustrate an example method for the system as described with reference to FIGS. 1-10, in accordance with an embodiment of the present invention;

FIG. 12 illustrates a block diagram depicting a conventional client/server communication system; and

FIG. 13 illustrates a typical computer system that, when appropriately configured or designed, may serve as a computer system for which the present invention may be embodied.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

A payment system will be described which provides means and methods for performing secure financial transactions.

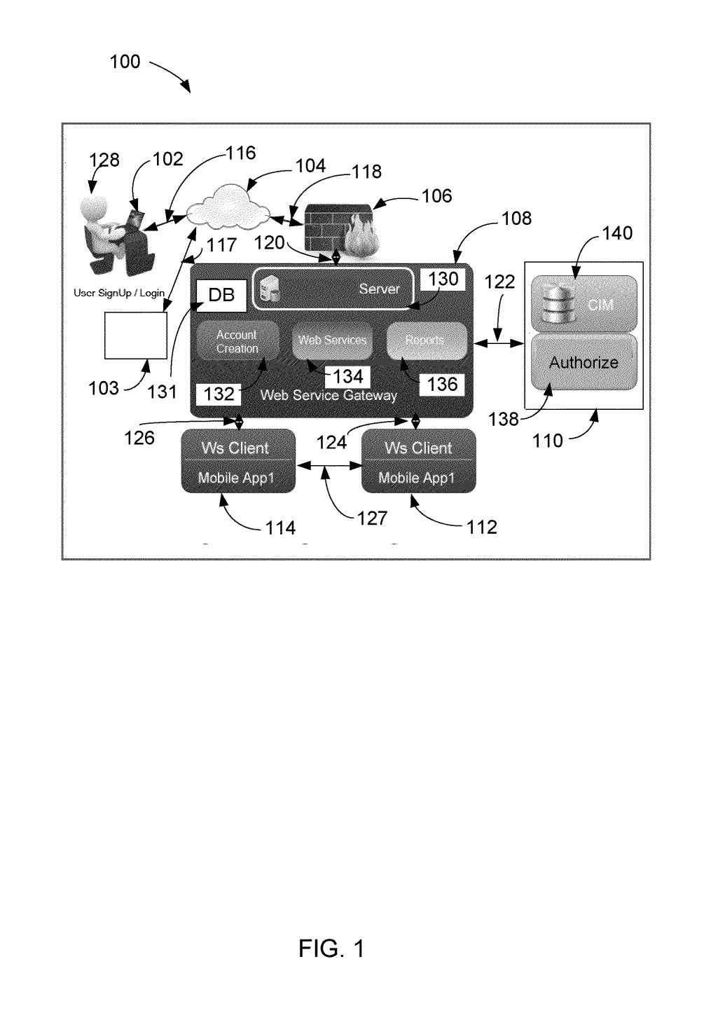

The system will now be described in detail with reference to FIGS. 1-14.

FIG. 1 is a diagram for the architecture of an example payment system, in accordance with an embodiment of the present invention.

A payment system 100 includes a computing device 102, a computing device 103, a global communications network 104, a firewall 106, a gateway 108, an authorization portion 110, a client 112 and a client 114.

Computing device 102 communicates bi-directionally with global communications network 104 via a communication channel 116. Computing device 103 communicates bi-directionally with global communications network 104 via a communication channel 117. Global communications network 104 communicates bi-directionally with firewall 106 via a communication channel 118. Firewall 106 communicates bi-directionally with gateway 108 via a communication channel 120. Gateway 108 communicates bi-directionally with authorization portion 110 via a communication channel 122 with client 112 via a communication channel 124 and with client 114 via a communication channel 126. Client 112 and client 114 communicate bi-directionally via a communication channel 127.

Computing device 102 receives, transmits, stores, retrieves and presents information to a user 128. Computing device 103 receives, transmits, stores, retrieves and presents information. As a non-limiting example, computing device 103 may operate for administrative purposes. Non-limiting examples for administrative purposes include account management, request review, request approval, request denial and password recovery. Global communications network 104 receives, transmits and transfers information. Firewall 106 provides for secure communication associated with authorized users. Gateway 108 receives, transmits, processes, stores and retrieves information. Authorization portion 110 provides capability for authorizing financial transactions. Client 112 and client 114 receives, transmits, stores, retrieves processes and presents information. As a non-limiting example, client 112 and client 114 provide application processing.

Gateway 108 includes a server 130, a database portion 131, an account creation portion 132, a web services portion 134 and a reports portion 136.

Account creation portion 132, web services portion 134 and reports portion 136 provide processing associated with server 130.

Server 130 receives, transmits, processes, stores and retrieves information. Database portion 131 receives, transmits, stores and retrieves information. Account creation portion 132 provides capability for creating an account. Web services portion 134 provides web services. Reports portion 136 provides capability for generating reports.

Authorization portion 110 includes an authorize portion 138 and a Customer Information Management (CIM) portion 140.

Authorize portion 138 provides authorization associated with customer information receipt, transfer, storage and retrieval and authorization associated with financial transactions. Authorize portion 138 may be configured as Payment Card Industry (PCI) compliant. CIM portion 140 provides customer information management.

System provides capability for international currency transactions as well as multiple currency transactions. Furthermore, system provides for capability for adding funds to an account via prepaid methods. System provides the capability to transfer funds from a credit card to a bank account and from a bank account to a bank account. Furthermore, system provides capability for account disable for suspicious account activity.

In operation, payment system 100 provides capability for performing financial transactions associated with client 112 and client 114.

FIG. 1 is a diagram for the architecture of an example payment system where information may be communicated and processed and execution of financial transactions may be performed.

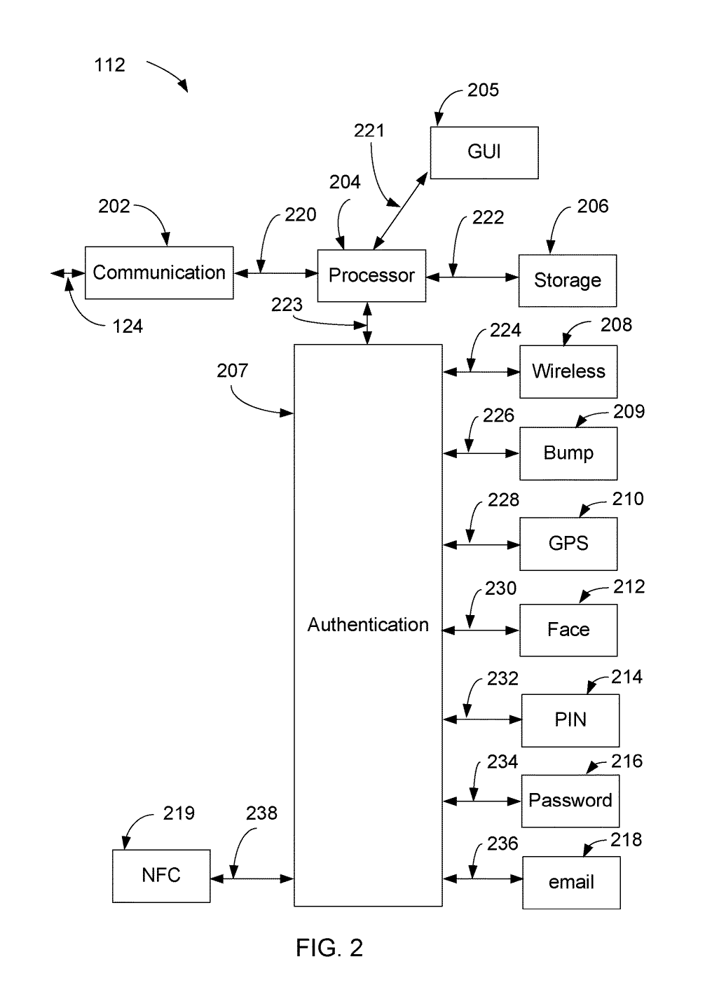

FIG. 2 is a block diagram for the example client described with reference to FIG. 1, in accordance with an embodiment of the present invention.

Client 112 and client 114 typically include a communication portion 202, a processor portion 204, a Graphical User Interface (GUI) portion 205, a storage portion 206, an authentication portion 207, a wireless portion 208, a bump portion 209, a Global Positioning System (GPS) portion 210, a face portion 212, a Personal Identification Number (PIN) portion 214, a password portion 216, an email portion 218 and a Near Field Communications (NFC) portion 219.

Communication portion 202 communicates bi-directionally with external entities via communication channel 124 and communicates bi-directionally with processor portion 204 via a communication channel 220. Processor portion 204 communicates bi-directionally with GUI portion 205 via a communication channel 221, communicates bi-directionally with storage portion 206 via a communication channel 222 and with authentication portion 207 via a communication channel 223. Authentication portion 207 communicates bi-directionally with wireless portion 208 via a communication channel 224 with bump portion 209 via a communication channel 226 with GPS portion 210 via a communication channel 228 with face portion 212 via a communication channel 230 with PIN portion 214 via a communication channel 232, with password portion 216 via a communication channel 234, with email portion 218 via a communication channel 236 and with NFC portion 219 via a communication channel 238.

Communication portion 202 provides capability for communicating with other entities. Processor portion 204 provides capability for receiving, transmitting and processing received information. GUI portion 205 provides capability for receiving, transmitting and presenting information. Storage portion 206 provides capability for receiving, transmitting, storing and retrieving information. Authentication portion 207 provides capability for processing associated with authentication. Wireless portion 208 provides capability for processing associated with wireless communication. As a non-limiting example, wireless portion 208 may be configured for Bluetooth. Bump portion 209 provides capability for processing associated with bump communication. As a non-limiting example, bump portion 209 may include an accelerometer for determining an acceleration and deceleration associated with a bump operation. GPS portion 210 provides capability for processing associated with GPS communication and GPS location. Face portion 212 provides capability for processing associated with facial recognition. PIN portion 214 provides capability for processing associated with PIN. Password portion 216 provides capability for processing associated with password. Email portion 218 provides capability for processing associated with email. NFC portion 219 provides capability for processing associated with near field communications.

In operation, client 112 and client 114 provide capability for receiving, transmitting, storing and retrieving information associated with financial transactions. Furthermore, client 112 and 114 provide capability to perform verification associated with a user via wireless, bump, GPS, Face, PIN, password, email and NFC.

FIG. 2 is a block diagram for the client described with reference to FIG. 1 where processing associated with authentication is performed.

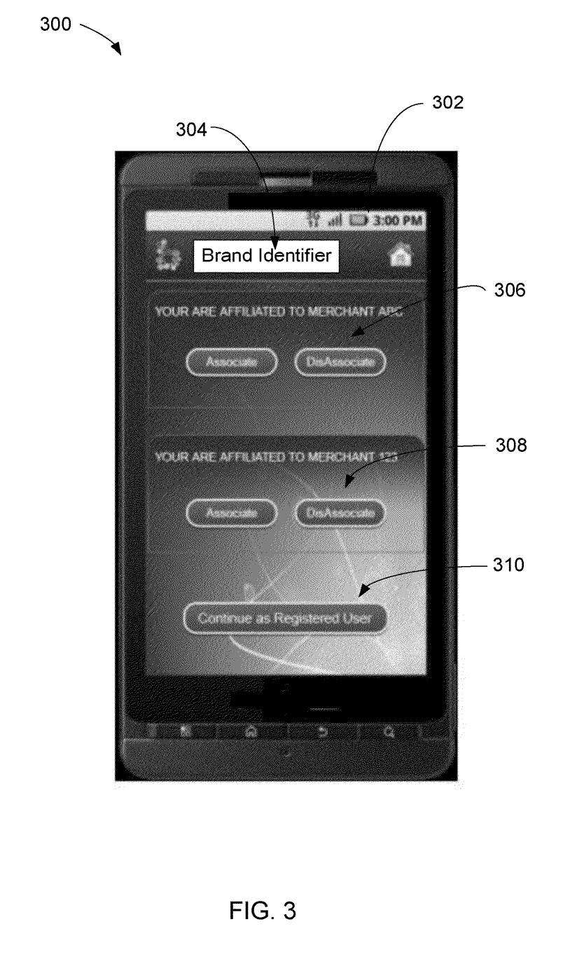

FIG. 3 is a presentation for the example client described with reference to FIGS. 1-2, in accordance with an embodiment of the present invention.

A presentation 300 includes an informational portion 302, a brand identifier portion 304, a selection portion 306, a selection portion 308 and a continue selection 310.

Informational portion 302 provides information associated with operation. Non-limiting examples of information presented include network identifier, signal strength, battery condition and time of day. Brand identifier portion 304 provides information associated with brand. Selection portion 306 and selection portion 308 provide capability for executing a selection. Non-limiting examples for choices for selection portion 306 and selection portion 308 include associating and de-associating with a merchant account. Continue selection 310 provides capability for continued operation. As a non-limiting example, continue selection 310 provides capability for continuing as a registered user.

In operation, a user selects to associated or de-associated with a merchant or merchants. Associating with a merchant enables continued interaction with the merchant and de-associating inhibits further interaction with the merchant.

FIG. 3 is a presentation for the example client described with reference to FIGS. 1-2 where a user may associate or de-associate with a merchant or merchants.

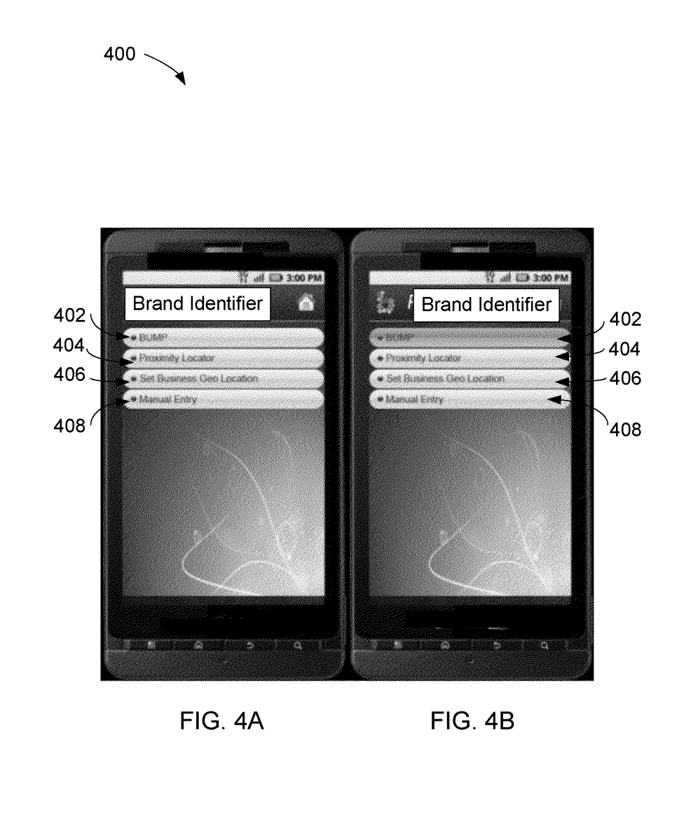

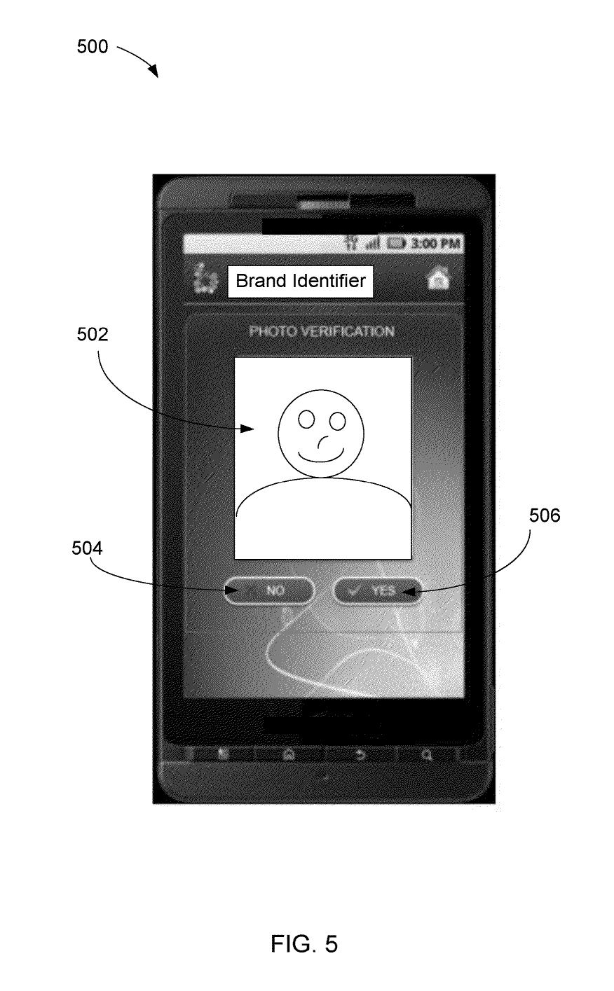

FIG. 4A is a presentation for the example client described with reference to FIGS. 1-2, in accordance with an embodiment of the present invention.

A presentation 400 includes a bump selection 402, a proximity locator selection 404, a business geographic location selection 406 and a manual entry selection 408.

As a non-limiting example, presentation 400 may be described as the home screen.

Bump selection 402 provides capability for selecting to execute a bump operation. Proximity locator selection 404 provides capability for performing a proximity location operation. Business geographic location selection 406 provides capability for configuring business geographic location information. Manual entry selection 408 provides capability for entry of information manually a device which does not have a accelerometer for detecting bump operations. Furthermore, via manual operation, a user may enter information associated with a seller/merchant. Furthermore, submenus may be provided for associated with further operation.

Selection of bump verification 402, proximity locator selection 404, business geographic location selection 406 or manual entry selection 408 enables further operation associated with the respective selection.

FIG. 4A is a presentation for the example client described with reference to FIGS. 1-2 where a selection for a bump operation, proximity operation, a business geographic location operation or manual entry operation may be performed.

FIG. 4B is a presentation for the example client described with reference to FIGS. 1-2 and FIG. 4A, in accordance with an embodiment of the present invention.

In FIG. 4B, selection of bump selection 402 is illustrated with bump selection 402 highlighted.

FIG. 4B is a presentation for the example client described with reference to FIGS. 1-2 and FIG. 4A where highlight of a selection is presented.

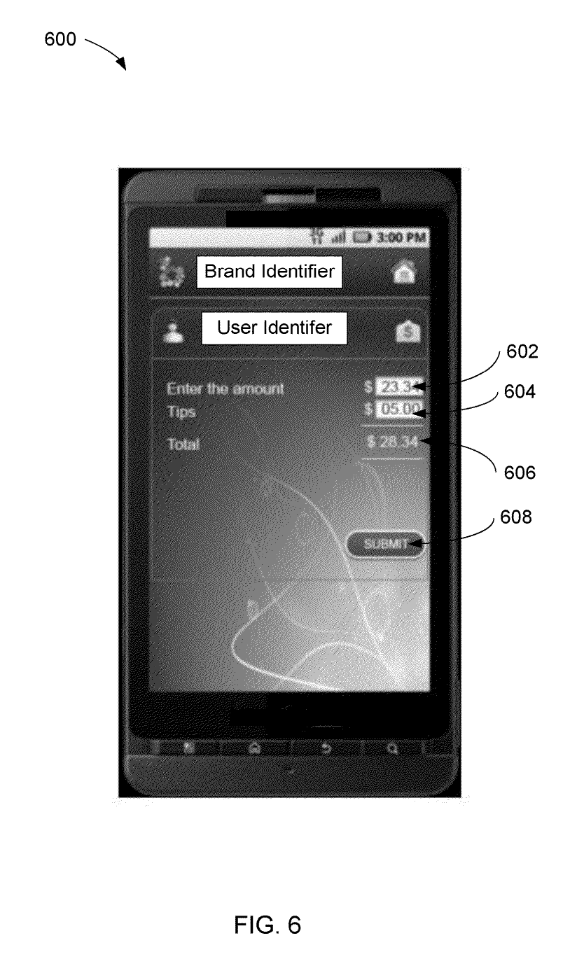

FIG. 5 is a presentation for the example client described with reference to FIGS. 1-2, in accordance with an embodiment of the present invention.

A presentation 500 includes an image portion 502, a negative selection 504 and an affirmative selection 506.

Image portion 502 presents an image for viewing. Negative selection 504 receives a negative selection. Affirmative selection 506 receives an affirmative selection.

In operation, image portion 502 is presented for viewing in order to authenticate a user. As a non-limiting example, verification may be performed associated with a bump operation. For authentication of a user associated with the presented image portion 502, an operator may select to confirm authentication via affirmative selection 506. For non-authentication of a user associated with the presented image portion 502, an operation may select to select negative selection 504 to negate authentication.

FIG. 5 is a presentation for the example client described with reference to FIGS. 1-2 where authentication of a user may be performed via affirmative selection or negative selection associated with a presented image.

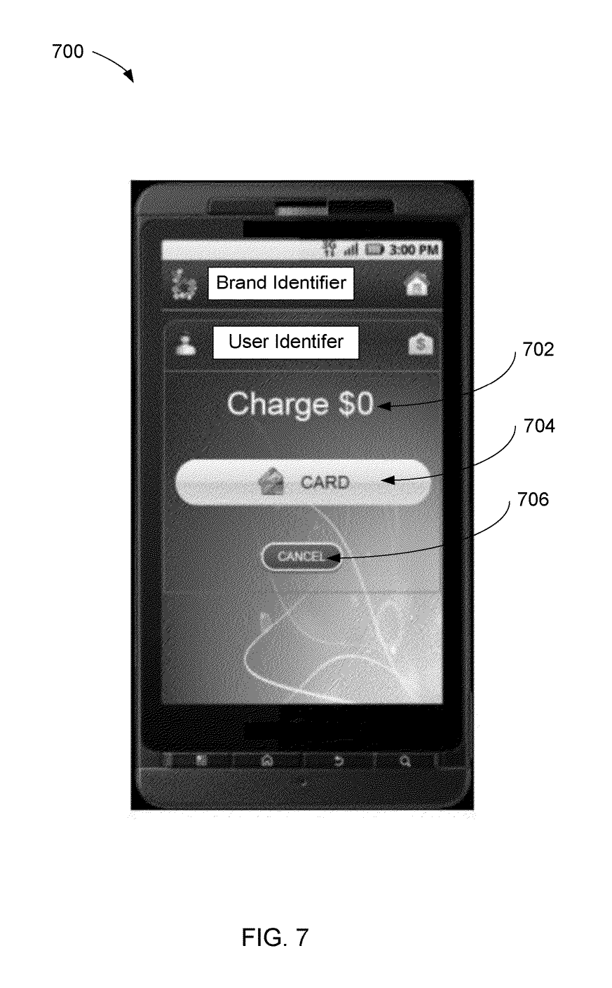

FIG. 6 is a presentation for the example client described with reference to FIGS. 1-2, in accordance with an embodiment of the present invention.

A presentation 600 includes an amount entry 602, a tip amount entry, a tax % breakup (automatically calculated) 604, a total presentation 606 and a submit selection 608.

Amount entry 602 provides capability for entering information associated with a purchase or financial transaction. Tip amount entry 604 provides capability for entering information associated with a tip for a purchase. Total presentation 606 presents information associated with the total amount of a purchase including a tip. Submit selection 608 enables selection for submitting a transaction for execution.

In operation, a user enters an amount in amount entry 602 associated with a purchase or financial transaction, optionally enters information associated with a tip, views information for the total amount of the transaction via total presentation 606 and selects to submit the transaction via submit selection 608.

FIG. 6 is a presentation for the example client described with reference to FIGS. 1-2 where a user may enter an amount, a tip amount, view the total amount for the transaction and select to submit the transaction for execution.

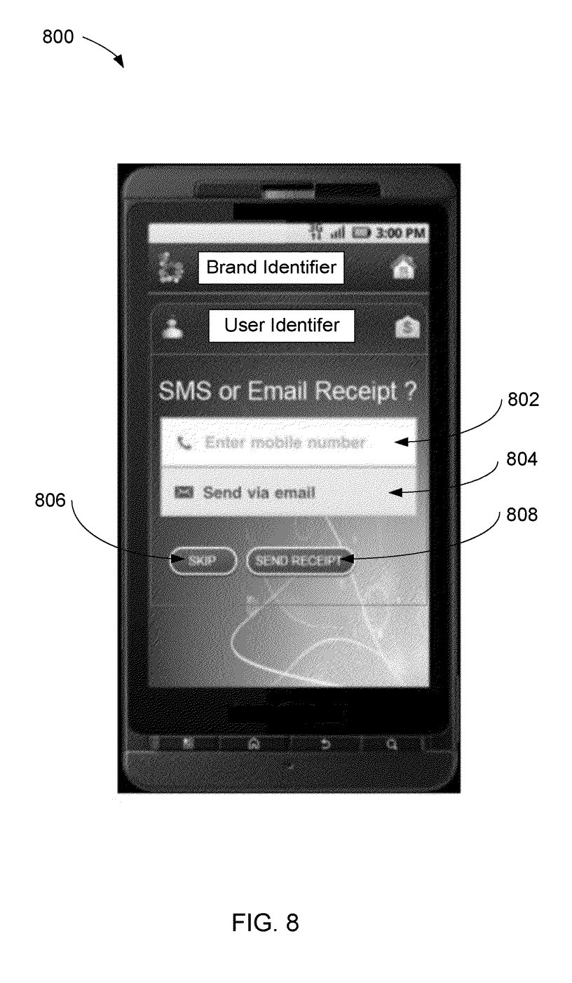

FIG. 7 is a presentation for the example client described with reference to FIGS. 1-2, in accordance with an embodiment of the present invention.

A presentation 700 includes an amount presentation 702, a card selection 704 and a cancel selection 706.

Amount presentation 702 presents an amount associated with a purchase or financial transaction. Card selection 704 enables selection of an account for executing a financial transaction. Non-limiting examples for the account include credit card and debit card. Cancel selection 706 enables canceling a financial transaction.

In operation, a user is presented an amount for a financial transaction and may select an account for executing the transaction. Furthermore, a user may cancel execution of a financial transaction.

FIG. 7 is a presentation for the example client described with reference to FIGS. 1-2 where a user is presented with a transaction amount and may select and account for executing the transaction or may cancel execution of the transaction.

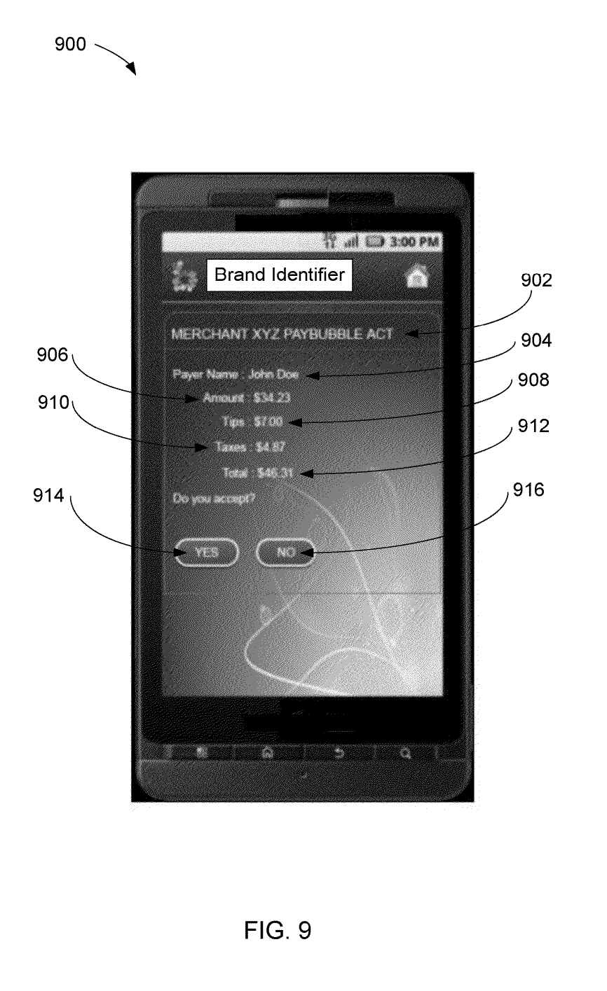

FIG. 8 is a presentation for the example client described with reference to FIGS. 1-2, in accordance with an embodiment of the present invention.

A presentation 800 includes a phone number selection 802, an email selection 804, a skip selection 806 and a send receipt selection 808.

Phone number selection 802 provides selection and entry of a phone number associated with communication of a receipt associated with a financial transaction. Email selection 804 provides selection and entry of an email address for communication of a receipt associated with a financial transaction. Skip selection 806 provides for selection of skipping communication of a receipt associated with a financial transaction. Send receipt selection 808 provides for selection of transmitting a receipt associated with the selected phone number or the selected email address.

In operation, following a financial transaction, a user is prompted to select to communicate the receipt associated with the financial transaction via phone number or email with execution of the communication initiated via selecting to send receipt. Furthermore, communication of the receipt may be skipped.

FIG. 8 is a presentation for the example client described with reference to FIGS. 1-2 where a user is prompted to select to communicate a receipt via phone number or email.

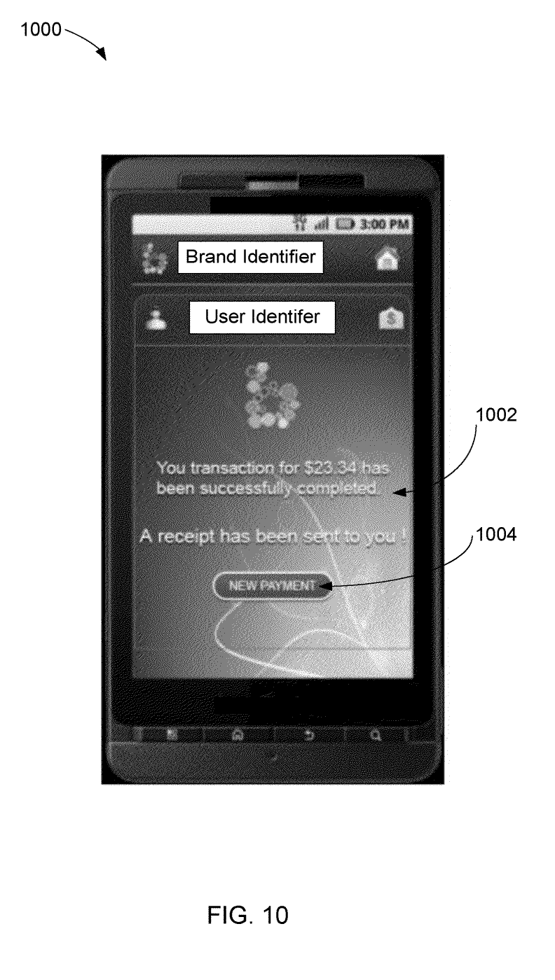

FIG. 9 is a presentation for the example client described with reference to FIGS. 1-2, in accordance with an embodiment of the present invention.

A presentation 900 includes an account presentation 902, a payer presentation 904, an amount presentation 906, a tip presentation 908, a taxes presentation portion 910, a total presentation 912, an affirmative selection 914 and a negative selection 916.

Account presentation 902 presents information for a merchant account associated with a financial transaction. Payer presentation 904 presents information associated with the payer executing the financial transaction. Amount presentation 906 presents information associated with the amount for the service or product purchased. Tip presentation 908 presents information associated with a tip for a transaction. Taxes presentation portion 910 presents information associated with taxes for a transaction. Total presentation 912 presents information associated with the total amount of a transaction. Affirmative selection 914 provides capability for affirming execution of a transaction. Negative selection 916 provides capability for declining execution of a transaction.

In operation, a user is presented with information associated with a financial transaction and may select to affirm or reject the financial transaction.

FIG. 9 is a presentation for the example client described with reference to FIGS. 1-2 where a user may view information associated with a transaction and may select to affirm or reject the transaction.

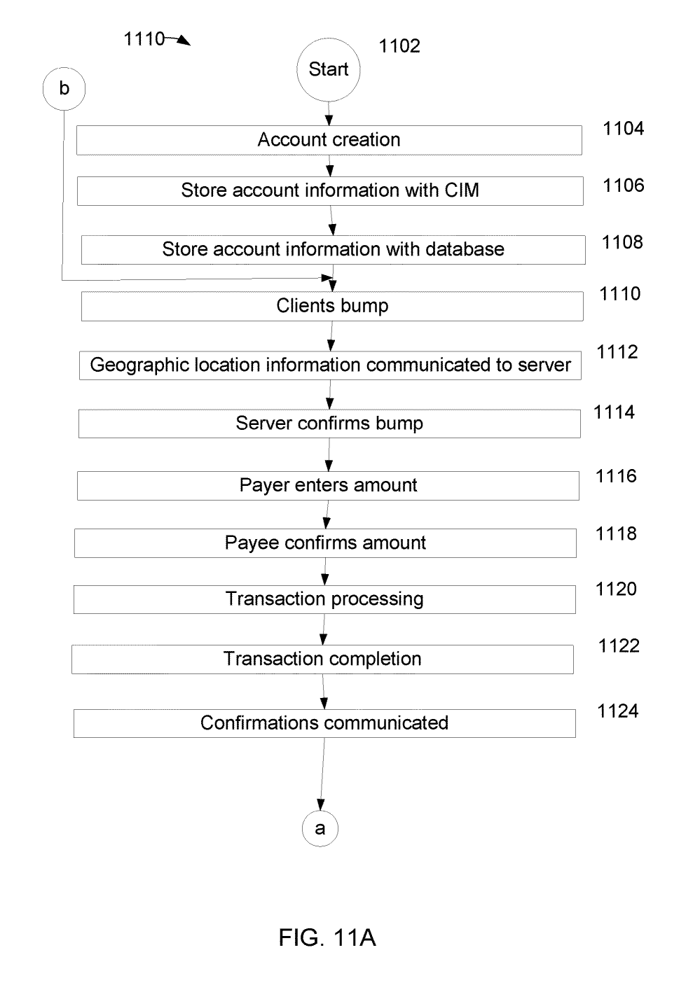

FIG. 10 is a presentation for the example client described with reference to FIGS. 1-2, in accordance with an embodiment of the present invention.

A presentation 1000 includes a transaction status presentation 1002 and a new payment selection 1004.

Transaction status presentation 1002 presents information associated with a transaction. As a non-limiting example, transaction status presentation 1002 may present information associated the amount of a successful transaction and acknowledgement of a sent receipt. New payment selection 1004 provides capability for selection to perform a new transaction.

In operation, a user is presented with information associated with a transaction and is provided an opportunity for selecting to execute a new payment.

FIG. 10 is a presentation for the example client described with reference to FIGS. 1-2 where a user is presented information associated with a transaction and is provided an opportunity to select to perform a new transaction.

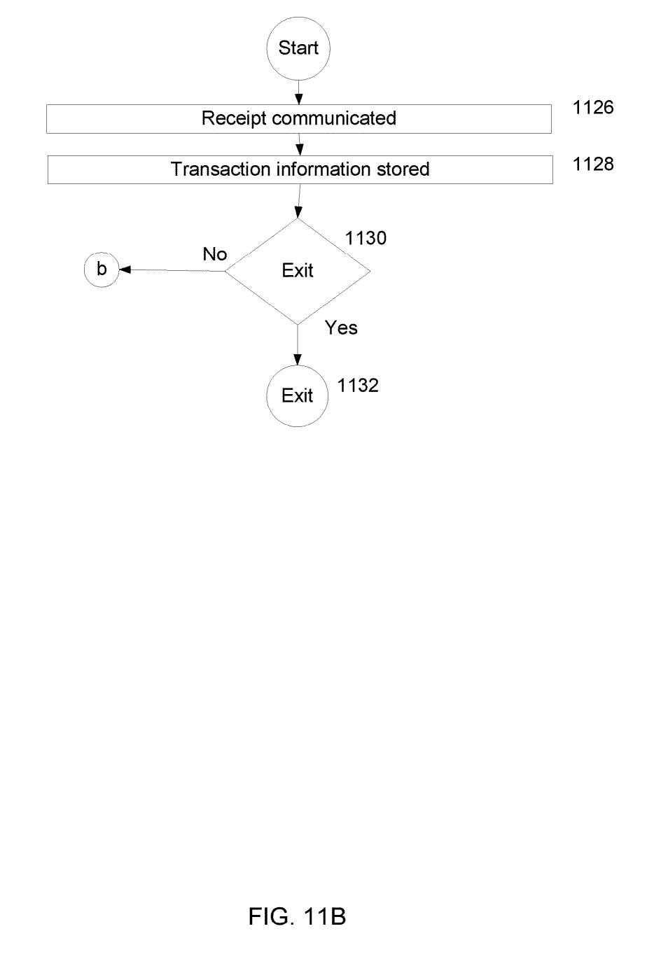

A method of performing the operation of the payment system as described with reference to FIGS. 1-10 will now be described with reference to FIG. 11.

FIGS. 11A-B illustrate an example method for the system as described with reference to FIGS. 1-10, in accordance with an embodiment of the present invention.

Referring to FIG. 11A, a method 1100 initiates in a step 1102.

Then in a step 1104, account creation is performed. User interface provides capability for user and/or merchant to create an account in order to subscribe for services. Non-limiting examples of operations performed include upload of digital photograph, credit card information and debit card information. As a non-limiting example, information associated with user account creation is communicated between computing device 102 (FIG. 1) and server 130 (FIG. 1). Non-limiting examples of information provided include name, email, phone number, gender, date of birth, mobile phone number and account type. As a non-limiting example, account type may be regular user or merchant. Following account creation, a user may be able to view information associated with the account. As a non-limiting example, the username associated with the account may be a provided email address. As a non-limited example, a user may be requested to enter an email address twice in order to verify a correct email address. As a non-limiting example, a user may be requested to upload a digital photographic image to be used for authentication process. As a non-limiting example, a user may be requested to enter a security question and an associated security answer in order to provide for secure operation. Information associated with account may be viewed by user. Non-limiting examples of information which may be viewed include transaction identification, user, transaction amount, transaction type, status of transaction. As a non-limiting example, type may be configured as paid or not paid. As a non-limiting example, status may indicate transaction as approved or pending. As a non-limiting example, the following information may be edited by user: account overview, account information, notification configuration, receipt address, credit/debit card information and security question. Non-limiting examples of information accessible by user associated with past history of financial transactions include daily report, monthly report, day of week report, time of day report, day of week report, user information and seller/merchant information. As a non-limiting example, a merchant/seller may select their business location as their geographic location associated with transaction processing. As a non-limiting example, the merchant's geographic location may be visible to the user. As a non-limiting example, the user may view merchants within a range of the user's client geographic location. As a non-limiting example, a user/seller/merchant may create sub accounts by entering information associated with the sub account holder. Information associated with sub account holder include, by way of example and not limitation, first name, last name and mobile phone number. Furthermore, when a user initiates a sub account, the associated application queries server for the account type. Furthermore, the server determines whether the user is a regular user or a sub account user. Furthermore, if the user is a regular user, the application proceeds as regular. Furthermore, if the user is a sub account holder, then information is presented indicating the user is a sub account holder of an associated merchant. A user associated with multiple accounts is prompted to select which account to attach a transaction. A user may opt to disassociate contact with a merchant and vice-versa. Furthermore, a user with an account as a regular user and a merchant user may be prompted whether to proceed as a regular user or a merchant user. Upon initiation of the application, a web service call is made to the server to check validity of the user using his/her phone number. If the User is a regular User, then operation proceeds to present the Home Screen. If the User is a Sub-Account holder for a Merchant, then operation proceeds as an affiliate of the Merchant and the Home Screen is presented. If the User is a Sub-Account holder of a merchant and also a regular user, then the user is prompted whether the user seeks to proceed as an affiliate or as a Regular User. If the User is a Sub-Account Holder of multiple merchants, then the user is prompted as to which Merchant the user seeks to associate with. Following selection of a Merchant for association operation proceeds to present the Home Screen. If the User is a Sub-Account Holder of multiple merchants and also a regular user, then the user is prompted as to which Merchant the user seeks to associate or given the option to continue as a regular User.

Referring back to FIG. 11A, then in a step 1106 account information is stored with CIM. As a non-limiting example, account information is communicated between server 130 (FIG. 1) and CIM portion 140 (FIG. 1).

Referring back to FIG. 11A, then in a step 1108 account information is stored in database.

As a non-limiting example, information, except credit card/debit card information, associated with user account creation is stored in database portion 131 (FIG. 1).

Referring back to FIG. 11A, then in a step 1110 clients perform a bump operation.

As a non-limiting example, a payer associated client 114 (FIG. 1) and a payee associated with client 112 (FIG. 1) bump devices with respective accelerometers associated with bump portion 209 (FIG. 2) detecting the bump operation.

Referring back to FIG. 11A, then in a step 1112 geographic location information is communicated to server.

As a non-limiting example, clients determine geographic location information via GPS portion 210 (FIG. 2) and communicate geographic location information to server 130 (FIG. 1). Furthermore, server 130 determines if client 112 (FIG. 1) and client 114 (FIG. 1) are located within the same general geographic location. Non-limiting examples of information communicated include latitude and longitude for the respective devices. Furthermore, phone number and user login information may be communicated to server 130. Furthermore, server 130 determines associated user identifications associated with received information. A user may be requested to indicate whether the user is a payer or a payee.

Referring back to FIG. 11A, then in a step 1114 server confirms bump operation.

As a non-limiting example, server 130 (FIG. 1) confirms bump operation via photo identification as described with reference to FIG. 5. Furthermore, server determines information associated with payer and payee and confirms information associated with transaction between payee and payer.

Referring back to FIG. 11A, then in a step 1116 payer enters amounts associated with transaction.

As a non-limiting example, payer enters amount and tip information associated with payment via client 114 (FIG. 1) as described with reference to FIG. 6.

Referring back to FIG. 11A, then in a step 1118 payee confirms amount for transaction.

Payee confirms amount of transaction via client 112 (FIG. 1) as described with reference to FIG. 9.

Referring back to FIG. 11A, then in a step 1120 transaction processing is performed.

Server 130 (FIG. 1) initiates the transaction via authorize portion 138 (FIG. 1) between payer associated with client 114 (FIG. 1) and payee associated with client 112 (FIG. 1). The amount to be paid by the payer is credited/debited from the payer's credit/debit card associated with CIM portion 140 (FIG. 1). Furthermore, the associated debit/credit is performed for to the associated merchant account. As a non-limiting example, credit/debit card transactions may take 2 to 3 days to complete. As a non-limiting example, the amount to be debited to the payee account may be performed manually once the payment receipt is confirmed.

Referring back to FIG. 11A, then in a step 1122 transaction processing is completed.

Authorize portion 138 (FIG. 1) processes and completes the transaction.

Referring back to FIG. 11A, then in a step 1124 confirmation information is communicated.

Confirmation information associated with the status of the transaction is communicated to payer associated with client 114 (FIG. 1) and to payee associated with client 112 (FIG. 1). As a non-limiting example, a user may be prompted as to whether a receipt is to be communicated via email. As a non-limiting example, a user may view transactions online access.

Referring to FIG. 11B, then in a step 1126 receipt information communicated to payer and payee.

As a non-limiting example, receipt information is communicated to payer associated with client 114 (FIG. 1) and to payee associated with client 112 (FIG. 1). As a non-limiting example, receipt information may be communicated via email or SMS. As a non-limiting example, receipt information may be communicated to a receipt address. Non-limiting examples of receipt addresses include, but not limited to, mailing address and email address. Furthermore, receipt information may be printed to paper via online access.

Referring back to FIG. 11B, then in a step 1128 transaction information is stored.

As a non-limiting example, transaction information is stored in database portion 131 (FIG. 1). Furthermore, transaction information may be viewed by user/merchant/payee/payer via reports portion 136 (FIG. 1) and computing device 102 (FIG. 1) and/or computing device 103 (FIG. 1).

Referring back to FIG. 11B, then in a step 1130 determination for exiting method 1100 is performed

For a determination of not exiting method 1100 in step 1130, execution of method 1100 transitions to step 1110 (FIG. 11A).

For a determination of exiting method 1100 in step 1130, execution of method 1100 terminates in a step 1132 (FIG. 11B).

FIGS. 11A-B illustrate an example method for the system as described with reference to FIGS. 1-10 where account creation is performed, account information is stored via CIM, account information is stored via database, clients perform bump operation, geographic location information is processed, server confirms bump operation, payer enters amount, payee confirms amount, transaction is processed, transaction is completed, confirmations are communicated, receipts are communicated and transaction information is stored.

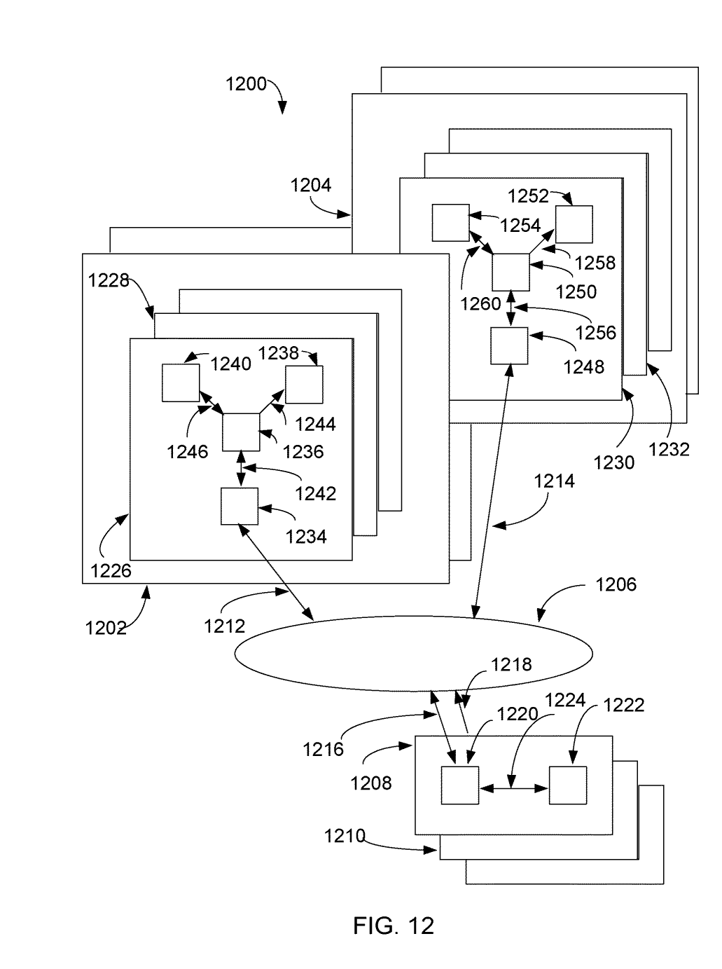

FIG. 12 illustrates a block diagram depicting a conventional client/server communication system.

A communication system 1200 includes a multiplicity of networked regions with a sampling of regions denoted as a network region 1202 and a network region 1204, a global network 1206 and a multiplicity of servers with a sampling of servers denoted as a server device 1208 and a server device 1210.

Network region 1202 and network region 1204 may operate to represent a network contained within a geographical area or region. Non-limiting examples of representations for the geographical areas for the networked regions may include postal zip codes, telephone area codes, states, counties, cities and countries. Elements within network region 1202 and 1204 may operate to communicate with external elements within other networked regions or within elements contained within the same network region.

In some implementations, global network 1206 may operate as the Internet. It will be understood by those skilled in the art that communication system 1200 may take many different forms. Non-limiting examples of forms for communication system 1200 include local area networks (LANs), wide area networks (WANs), wired telephone networks, cellular telephone networks or any other network supporting data communication between respective entities via hardwired or wireless communication networks. Global network 1206 may operate to transfer information between the various networked elements.

Server device 1208 and server device 1210 may operate to execute software instructions, store information, support database operations and communicate with other networked elements. Non-limiting examples of software and scripting languages which may be executed on server device 1208 and server device 1210 include C, C++, C# and Java.

Network region 1202 may operate to communicate bi-directionally with global network 1206 via a communication channel 1212. Network region 1204 may operate to communicate bi-directionally with global network 1206 via a communication channel 1214. Server device 1208 may operate to communicate bi-directionally with global network 1206 via a communication channel 1216. Server device 1210 may operate to communicate bi-directionally with global network 1206 via a communication channel 1218. Network region 1202 and 1204, global network 1206 and server devices 1208 and 1210 may operate to communicate bi-directionally and also communicate bi-directionally with other networked device located within communication system 1200.

Server device 1208 includes a networking device 1220 and a server 1222. Networking device 1220 may operate to communicate bi-directionally with global network 1206 via communication channel 1216 and with server 1222 via a communication channel 1224. Server 1222 may operate to execute software instructions and store information.

Network region 1202 includes a multiplicity of clients with a sampling denoted as a client 1226 and a client 1228. Client 1226 includes a networking device 1234, a processor 1236, a GUI 1238 and an interface device 1240. Non-limiting examples of devices for GUI 1238 include monitors, televisions, cellular telephones, smartphones and PDAs (Personal Digital Assistants). Non-limiting examples of interface device 1240 include pointing device, mouse, trackball, scanner and printer. Networking device 1234 may communicate bi-directionally with global network 1206 via communication channel 1212 and with processor 1236 via a communication channel 1242. GUI 1238 may receive information from processor 1236 via a communication channel 1244 for presentation to a user for viewing. Interface device 1240 may operate to send control information to processor 1236 and to receive information from processor 1236 via a communication channel 1246. Network region 1204 includes a multiplicity of clients with a sampling denoted as a client 1230 and a client 1232. Client 1230 includes a networking device 1248, a processor 1250, a GUI 1252 and an interface device 1254. Non-limiting examples of devices for GUI 1238 include monitors, televisions, cellular telephones, smartphones and PDAs (Personal Digital Assistants). Non-limiting examples of interface device 1240 include pointing devices, mousse, trackballs, scanners and printers. Networking device 1248 may communicate bi-directionally with global network 1206 via communication channel 1214 and with processor 1250 via a communication channel 1256. GUI 1252 may receive information from processor 1250 via a communication channel 1258 for presentation to a user for viewing. Interface device 1254 may operate to send control information to processor 1250 and to receive information from processor 1250 via a communication channel 1260.

For example, consider the case where a user interfacing with client 1226 may want to execute a networked application. A user may enter the IP (Internet Protocol) address for the networked application using interface device 1240. The IP address information may be communicated to processor 1236 via communication channel 1246. Processor 1236 may then communicate the IP address information to networking device 1234 via communication channel 1242. Networking device 1234 may then communicate the IP address information to global network 1206 via communication channel 1212. Global network 1206 may then communicate the IP address information to networking device 1220 of server device 1208 via communication channel 1216. Networking device 1220 may then communicate the IP address information to server 1222 via communication channel 1224. Server 1222 may receive the IP address information and after processing the IP address information may communicate return information to networking device 1220 via communication channel 1224. Networking device 1220 may communicate the return information to global network 1206 via communication channel 1216. Global network 1206 may communicate the return information to networking device 1234 via communication channel 1212. Networking device 1234 may communicate the return information to processor 1236 via communication channel 1242. Processor 1236 may communicate the return information to GUI 1238 via communication channel 1244. User may then view the return information on GUI 1238.

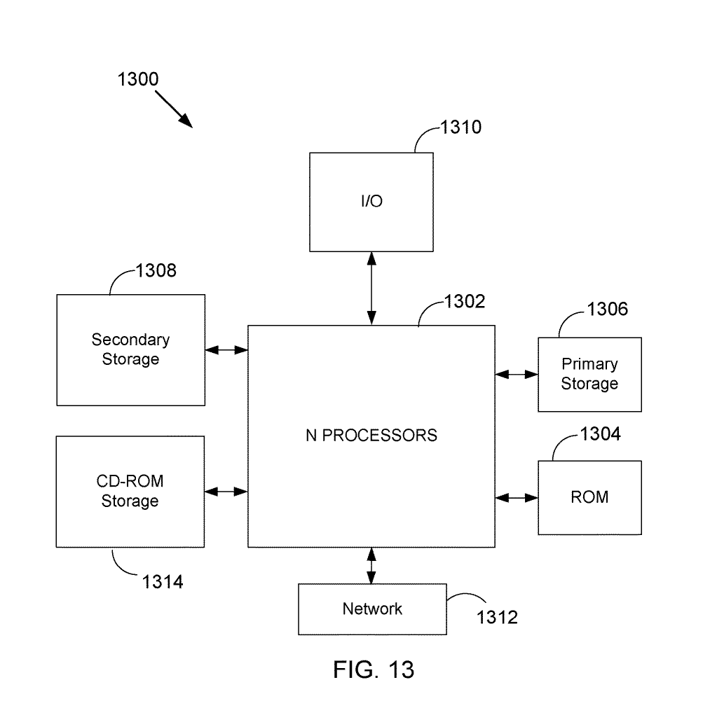

FIG. 13 illustrates a typical computer system that, when appropriately configured or designed, may serve as a computer system 1300 for which the present invention may be embodied.

Computer system 1300 includes a quantity of processors 1302 (also referred to as central processing units, or CPUs) that may be coupled to storage devices including a primary storage 1306 (typically a random access memory, or RAM), a primary storage 1304 (typically a read-only memory, or ROM). CPU 1302 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 1304 acts to transfer data and instructions uni-directionally to the CPU and primary storage 1306 typically may be used to transfer data and instructions in a bi-directional manner. The primary storage devices discussed previously may include any suitable computer-readable media such as those described above. A mass storage device 1308 may also be coupled bi-directionally to CPU 1302 and provides additional data storage capacity and may include any of the computer-readable media described above. Mass storage device 1308 may be used to store programs, data and the like and typically may be used as a secondary storage medium such as a hard disk. It will be appreciated that the information retained within mass storage device 1308, may, in appropriate cases, be incorporated in standard fashion as part of primary storage 1306 as virtual memory. A specific mass storage device such as a CD-ROM 1314 may also pass data uni-directionally to the CPU.

CPU 1302 may also be coupled to an interface 1310 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1302 optionally may be coupled to an external device such as a database or a computer or telecommunications or internet network using an external connection shown generally as a network 1312, which may be implemented as a hardwired or wireless communications link using suitable conventional technologies. With such a connection, the CPU might receive information from the network, or might output information to the network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: servers and global communication network.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of a payment system according to the present invention will be apparent to those skilled in the art. The invention has been described above by way of illustration, and the specific embodiments disclosed are not intended to limit the invention to the particular forms disclosed. For example, the particular implementation of the client may vary depending upon the particular type communication device used. The clients described in the foregoing were directed to smartphone implementations; however, similar techniques using tabular device implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A method comprising the steps of:
initializing at least a financial transaction between a first user and a second user, in which the first user and the second user have created accounts by communicating with a server system, the account of the first user being associated with at least a first user's client device, and the account of the second user being associated with at least a second user's client device;
recognizing a contact between the first user's client device and the second user's client device;
obtaining a geographical location upon said recognizing;
communicating at least the geographical location to the server system for comparison with a geographical location communicated by the other client device, in which the comparison at least, in part, determines a validity of the financial transaction;
receiving at least a confirmation of the comparison from the server system;
communicating at least an amount for the financial transaction to the server system for transaction processing; and
receiving at least a confirmation of the transaction processing.

2. The method as recited in claim 1, further comprising the step of requesting a receipt for the financial transaction.

3. The method as recited in claim 2, further comprising selecting a delivery means for the receipt.

4. The method as recited in claim 1, further comprising the step of authenticating a user for the financial transaction by acceptance of an image displayed on a client device.

5. The method as recited in claim 4, in which the image is a photographic representation of the user.

6. The method as recited in claim 1, in which the contact between the first user's client device and the second user's client device comprises a physical bump.

7. The method as recited in claim 1, in which the contact between the first user's client device and the second user's client device comprises a wireless communication.

8. The method as recited in claim 7, in which said wireless communication comprises a near field communication link.

9. A system comprising:
a server system being configured to be operable for at least maintaining accounts for a first user and a second user, comparing geographical locations of the first user and the second user during a financial transaction between the first user and the second user in which the comparison at least, in part, determines a validity of the financial transaction, and completing the financial transaction;
a first user's client device being configured to be operable for communicating with said server system for at least engaging in the financial transaction, recognizing a contact of a client device during the financial transaction, and obtaining a geographical location of said first user's client device during the financial transaction for the comparison; and
a second user's client device being configured to be operable for communicating with said server system for at least engaging in the financial transaction, recognizing a contact of a client device during the financial transaction, and obtaining a geographical location of said second user's client device during the financial transaction for the comparison, in which said first user's client device and said second user's client device at least receive a confirmation of the comparison from the server system and a confirmation of the transaction processing.

10. The system as recited in claim 9, in which said server system is further configured to be operable for communicating receipts for the financial transaction.

11. The system as recited in claim 10, in which the receipts are sent via a selected delivery means.

12. The system as recited in claim 9, said first user's client device and said second user's client device are further configured to be operable for authenticating a user for the financial transaction by acceptance of an image displayed on the client device.

13. The system as recited in claim 12, in which the image is a photographic representation of the user.

14. The system as recited in claim 9, in which a contact between the first user's client device and the second user's client device comprises a physical bump.

15. The system as recited in claim 9, in which the contact between the first user's client device and the second user's client device comprises a wireless communication.

16. The system as recited in claim 15, in which said wireless communication comprises a near field communication link.

17. A non-transitory program storage device readable by a machine tangibly embodying a program of instructions executable by the machine to perform a method for presenting advertisement, comprising:
computer code for initializing at least a financial transaction between a first user and a second user, in which the first user and the second user have created accounts by communicating with a server system, the account of the first user being associated with at least a first user's client device, and the account of the second user being associated with at least a second user's client device;
computer code for recognizing a contact between the first user's client device and the second user's client device;
computer code for obtaining a geographical location upon said recognizing;
computer code for communicating at least the geographical location to the server system for comparison with a geographical location communicated by the other client device, in which the comparison at least, in part, determines a validity of the financial transaction;
computer code for receiving at least a confirmation of the comparison from the server system;
computer code for communicating at least an amount for the financial transaction to the server system for transaction processing; and
computer code for receiving at least a confirmation of the transaction processing.

18. The non-transitory program storage device as recited in claim 17, further comprising:
computer code for requesting a receipt for the financial transaction;
computer code for selecting a delivery means for the receipt; and
computer code for authenticating a user for the financial transaction by acceptance of an image displayed on a client device in which the image is a photographic representation of the user.

19. The non-transitory program storage device as recited in claim 18, in which the contact between the first user's client device and the second user's client device comprises a physical bump.

20. The non-transitory program storage device as recited in claim 18, in which the contact between the first user's client device and the second user's client device comprises a wireless communication, said communication comprising a receipt confirming the executed payment, said receipt comprising descriptive information regarding the nature and/or context of the payment.
